(19) United States
(12) Patent Application Publication
(10) Pub. No.: US 2016/0266543 A1
(43) Pub. Date: Sep. 15, 2016

(54) THREE-DIMENSIONAL IMAGE SOURCE FOR ENHANCED PEPPER'S GHOST ILLUSION

(71) Applicant: VENTANA 3D, LLC, Van Nuys, CA (US)

(72) Inventors: Ashley Crowder, Venice, CA (US); Benjamin Conway, Santa Monica, CA (US); Troy P. Senkiewicz, Toluca Lake, CA (US); James M. Behmke, Pembroke, MA (US)

(21) Appl. No.: 15/065,160

(22) Filed: Mar. 9, 2016

Related U.S. Application Data
(60) Provisional application No. 62/129,987, filed on Mar. 9, 2015.
(60) Provisional application No. 62/130,244, filed on Mar. 9, 2015.

(51) Int. Cl. G03H 1/22; G03H 1/08

(52) U.S. Cl. CPC G03H 1/2202; G03H 1/0866; G03H 1/2249; G03H 2001/2252

(57) ABSTRACT

Systems and methods herein are directed to three-dimensional image sources for an enhanced Pepper's Ghost Illusion. In one embodiment, a contoured bounce is described, allowing for contorting a bounce to different shapes, giving it enhanced three-dimensional (3D) effect. For instance, the bounce may include certain topography (raised portions), or else may actually comprise various 3D shapes (e.g., cubes, semi-spheres, etc.). In another embodiment, a multi-level image source is described, allowing for multiple image sources (e.g., projected bounces and/or panel displays) to be used and placed at different heights with respect to a transparent viewing screen, thus projecting images that appear at various depths, increasing the three-dimensional (3D) effect of the Pepper's Ghost Illusion. In addition, in one embodiment, the heights of the image sources may be adjusted (e.g., dynamically), making corresponding holographic images change their depth perspective to an audience, further enhancing the 3D effect.

### RELATED APPLICATIONS

This application claims priority to U.S. Provisional Application No. 62/130,244 filed on Mar. 9, 2015 entitled CONTOURED BOUNCE FOR ENHANCED PEPPER'S GHOST ILLUSION, by Crowder, et al., and U.S. Provisional Application No. 62/129,987 filed on Mar. 9, 2015, entitled MULTI-LEVEL IMAGE SOURCE FOR ENHANCED PEPPER'S GHOST ILLUSION, by Crowder, et al., the contents of each of which are incorporated herein by reference.

### TECHNICAL FIELD

The present disclosure relates generally to holographic projection, and, more particularly, to a three-dimensional image source (e.g., contoured bounce and/or multi-level image source) for an enhanced Pepper's Ghost Illusion.

### BACKGROUND

The “Pepper's Ghost Illusion” is an illusion technique known for centuries (named after John Henry Pepper, who popularized the effect), and has historically been used in theatre, haunted houses, dark rides, and magic tricks. It uses plate glass, Plexiglas, or plastic film and special lighting techniques to make objects seem to appear or disappear, become transparent, or to make one object morph into another. Traditionally, for the illusion to work, the viewer must be able to see into a main room, but not into a hidden room. The hidden room may be painted black with only light-colored objects in it. When light is cast on the room, only the light objects reflect the light and appear as ghostly translucent images superimposed in the visible room.

Notably, Pepper's Ghost Illusion systems have generally remained the same since the 19th Century, adding little more over time than the use of projection systems that either direct or reflect light beams onto the transparent angled screen, rather than using live actors in a hidden room. That is, technologies have emerged in the field of holographic projection that essentially mimic the Pepper's Ghost Illusion, using projectors as the light source to send a picture of an object or person with an all-black background onto a flat, high-gain reflection surface (also referred to as a “bounce”), such as white or grey projection screen. The bounce is typically maintained at an approximate 45-degree angle to the transparent screen surface.

For example, a recent trend in live music performances has been to use a holographic projection of a performer (e.g., live-streamed, pre-recorded, or re-constructed). FIG. 1 illustrates an example of a conventional (generally large-scale) holographic projection system 100. Particularly, the streamed (or recorded, or generated) image of the artist (or other object) may be projected onto a reflective surface, such that it appears on an angled screen and the audience sees the artist or object and not the screen. If the screen is transparent, this allows for other objects, such as other live artists, to stand in the background of the screen, and to appear to be standing next to the holographic projection when viewed from the audience.

Still, despite its historic roots, holographic projection technology is an emerging field, particularly with regards to various aspects of enhancing the illusion and/or managing the setup of the system.

### SUMMARY

According to one or more embodiments herein, a three-dimensional image source for an enhanced Pepper's Ghost Illusion is shown and described. In particular, various embodiments are described that determine a desired three-dimensionality of one or more holographic objects; provide locational relationship between a holographic screen and one or more image sources corresponding to the one or more holographic objects to create a varied distance between the holographic screen and the one or more image sources based on the desired three-dimensionality of the one or more holographic objects; and display one or more images corresponding to the one or more holographic objects on the one or more image sources to present one or more three-dimensional holographic objects via the holographic screen based on the one or more images displayed on the locational relationships between the one or more image sources.

According to one or more specific embodiments herein, a contoured bounce for an enhanced Pepper's Ghost Illusion is shown and described. In particular, various embodiments are described that allow for contorting a bounce to different shapes, giving it enhanced three-dimensional (3D) effect. For instance, the bounce may include certain topography (raised portions), or else may actually comprise various 3D shapes (e.g., cubes, semi-spheres, etc.). In one embodiment, two or more projectors can be used to projection map the bounce from different angles/sides, thus creating a more realistic 3D effect, and allowing a person walking by the display to see a realistic perspective.

According to one or more additional specific embodiments herein, a multi-level image source for an enhanced Pepper's Ghost Illusion is shown and described. In particular, various embodiments are described that allow for multiple image sources (e.g., projected bounces and/or panel displays) to be used and placed at different heights with respect to a transparent viewing screen, thus projecting images that appear at various depths, increasing the three-dimensional (3D) effect of the Pepper's Ghost Illusion. In addition, in one embodiment, the heights of the image sources may be adjusted (e.g., dynamically), making corresponding holographic images change their depth perspective to an audience, further enhancing the 3D effect.

Other specific embodiments, extensions, or implementation details are also described below.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of well-known holographic projection techniques;

FIG. 2 illustrates an alternative arrangement for a projection-based holographic projection system, namely where the projector is located on the floor, and the bounce is located on the ceiling;

FIG. 3 illustrates an example of a holographic projection system using video panel displays, with the panel below a transparent screen;

FIG. 4 illustrates an example of a holographic projection system using video panel displays, with the panel above a transparent screen;

FIG. 5 illustrates an example simplified holographic projection system (e.g., communication network);

FIG. 6 illustrates a simplified example of an avatar control system;

FIGS. 7A-7B illustrate how a difference in height of an image source corresponds to a difference in perceived depth of a holographic object in accordance with one or more embodiments described herein;

FIG. 8 illustrates an example of a contoured image source in accordance with one or more embodiments described herein;

FIG. 9 illustrates another example of a contoured image source (human face) in accordance with one or more embodiments described herein;

FIG. 10 illustrates another example of a contoured image source (semi-sphere) in accordance with one or more embodiments described herein;

FIG. 11 illustrates another example of a contoured image source (cityscape) in accordance with one or more embodiments described herein;

FIGS. 12A-12C illustrate an example of side-to-side perspective of a 3D cube when using a contoured bounce in accordance with one or more embodiments herein;

FIG. 13 illustrates an example simplified procedure for using a contoured bounce for an enhanced Pepper's Ghost Illusion in accordance with one or more embodiments described herein;

FIG. 14 illustrates an example of multiple image sources at different heights, resulting in their correspondingly displayed images appearing at different depths to the viewer in accordance with one or more embodiments described herein;

FIGS. 15A-15B illustrate an example of how the heights of the image sources may be changed, resulting in a corresponding change in perceived depth of the objects in accordance with one or more embodiments described herein;

FIGS. 16A-16B illustrate an example of how the height of a single image source may be changed, resulting in a corresponding change in perceived depth of the object in accordance with one or more embodiments described herein;

FIGS. 17A-17B illustrate examples of a depth-based video capture device in accordance with one or more embodiments described herein;

FIGS. 18A-18D illustrate an example of depth-based video capture in accordance with one or more embodiments described herein;

FIG. 19 illustrates an example simplified procedure for using a multi-level image source for an enhanced Pepper's Ghost Illusion in accordance with one or more embodiments described herein; and

FIG. 20 illustrates an example simplified procedure for a three-dimensional image source for enhanced Pepper's Ghost Illusion, generally, in accordance with one or more embodiments described herein.

### DESCRIPTION OF EXAMPLE EMBODIMENTS

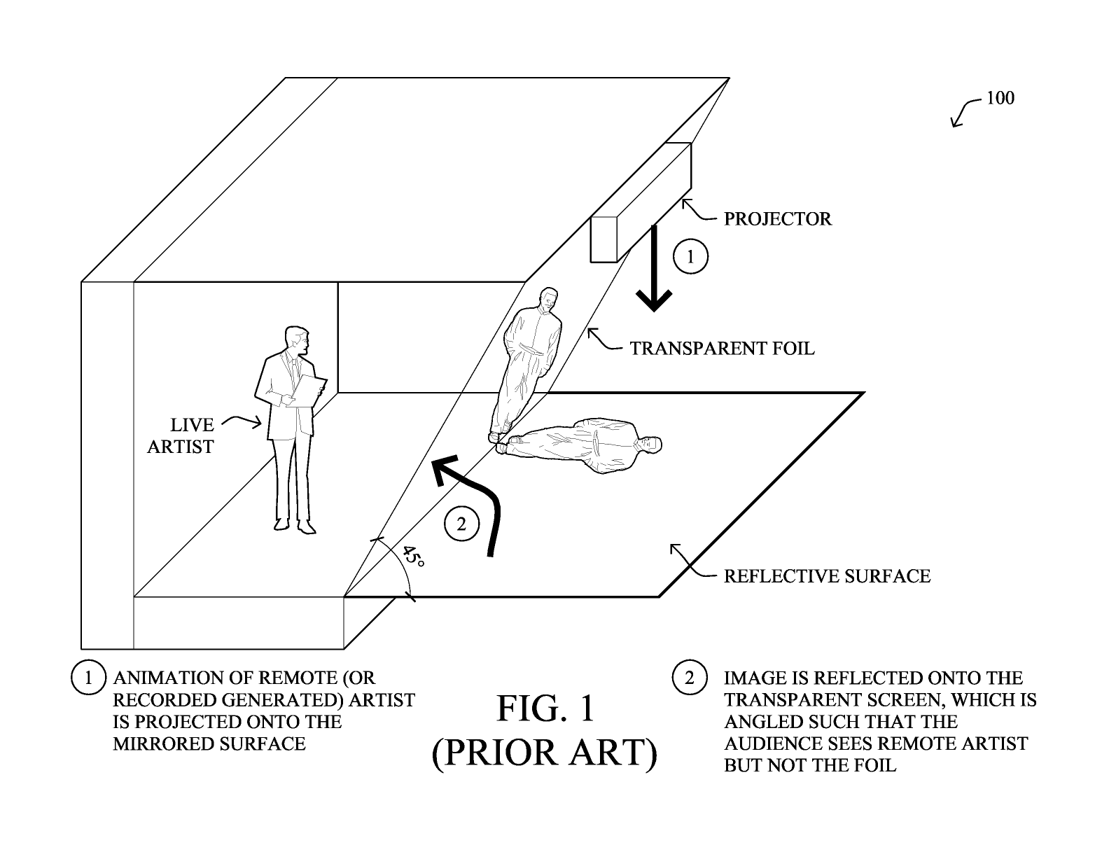

As noted above, the “Pepper's Ghost Illusion” is an illusion technique that uses plate glass, Plexiglas, or plastic film and special lighting techniques to make holographic projections of people or objects. FIG. 1, in particular, illustrates an example of holographic projection using projectors as the light source to send a picture of an object or person with an all-black background onto a flat, high-gain reflection surface (or “bounce”), such as white or grey projection screen. The bounce is typically maintained at an approximate 45-degree angle to the transparent screen surface.

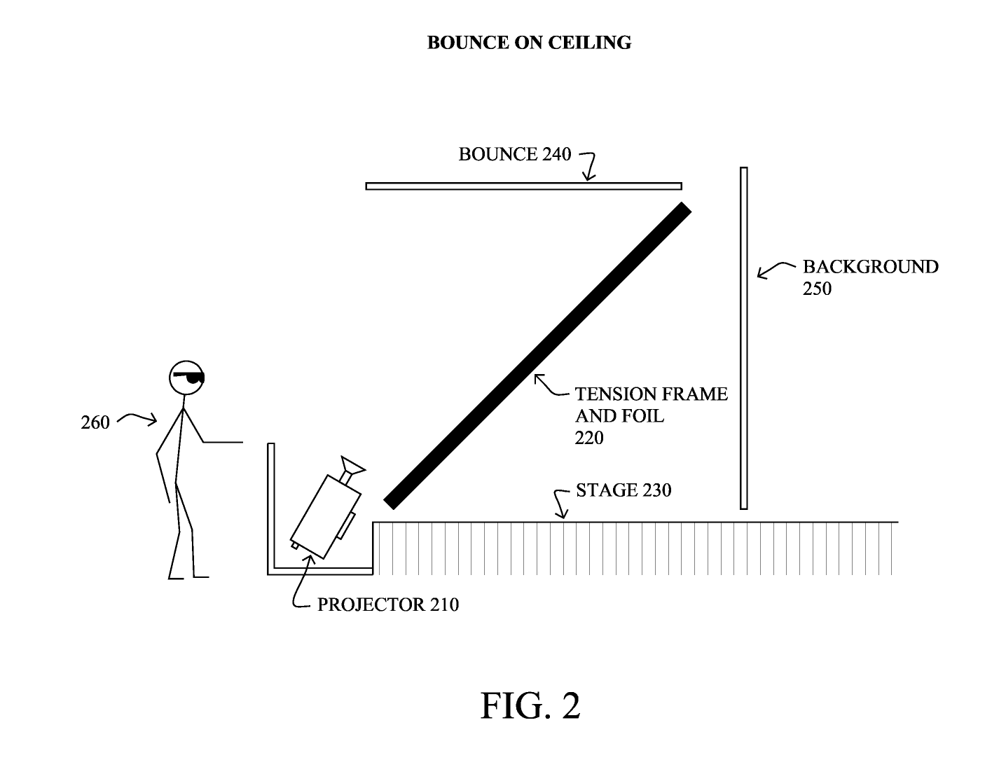

FIG. 2 illustrates an alternative arrangement for a projection-based holographic projection system, namely where the projector 210 is located on the floor, and the bounce 240 is located on the ceiling. The stick figure illustrates the viewer 260, that is, from which side one can see the holographic projection. In this arrangement, the same effect can be achieved as in FIG. 1, though there are various considerations as to whether to use a particular location of the projector 210 as in FIG. 1 or FIG. 2.

Though the projection-based system is suitable in many situations, particularly large-scale uses, there are certain issues with using projectors in this manner. For example, if atmosphere (e.g., smoke from a fog machine) is released, the viewer 260 can see where the light is coming from, thus ruining the effect. Also, projectors are not typically bright enough to shine through atmosphere, which causes the reflected image to look dull and ghost-like. Moreover, projectors are large and heavy which leads to increased space requirements and difficulty rigging.

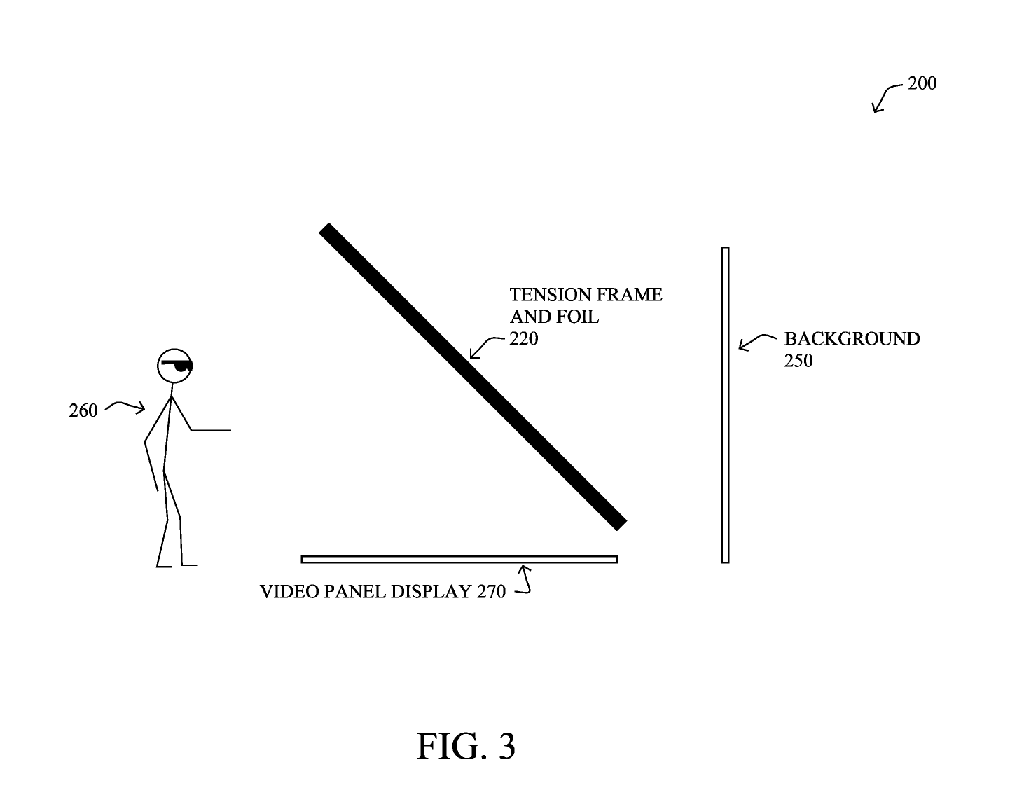

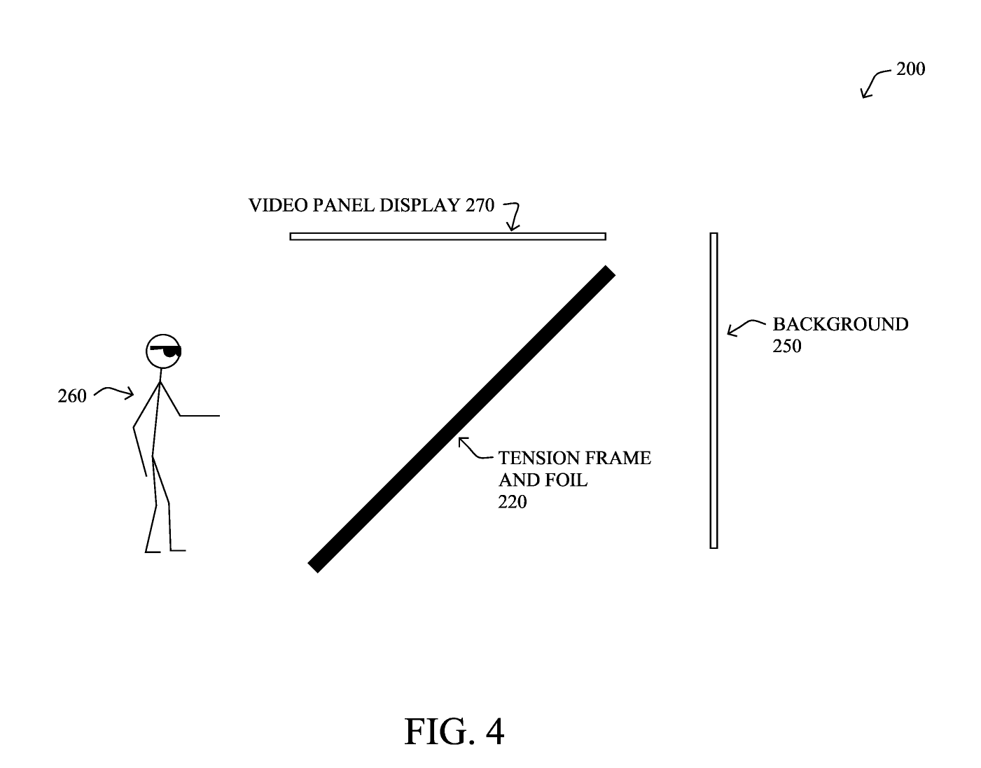

Another example holographic projection system, therefore, with reference generally to FIGS. 3 and 4, may be established with video panel displays 270, such as LED or LCD panels, mobile phones, tablets, laptops, or monitors as the light source, rather than a projection-based system. In particular, these panel-based systems allow for holographic projection for any size setup, such as from personal “mini” displays (e.g., phones, tablets, etc.) up to the larger full-stage-size displays (e.g., with custom-sized LCD or LED panels). Similar to the typical arrangement, a preferred angle between the image light source and the reflective yet transparent surface (clear screen) is an approximate 45-degree angle, whether the display is placed below the transparent screen (FIG. 3) or above it (FIG. 4).

Again, the stick figure illustrates the viewer 260, that is, from which side one can see the holographic projection. Note that the system typically provides about 165-degrees of viewing angle. (Also note that various dressings and props can be designed to hide various hardware components and/or to build an overall scene, but such items are omitted for clarity.)

The transparent screen is generally a flat surface that has similar light properties of clear glass (e.g., glass, plastic such as Plexiglas or tensioned plastic film). As shown, a tensioning frame 220 is used to stretch a clear foil into a stable, wrinkle-free (e.g., and vibration resistant) reflectively transparent surface (that is, displaying/reflecting light images for the holographic projection, but allowing the viewer to see through to the background). Generally, for larger displays it may be easier to use a tensioned plastic film as the reflection surface because glass or rigid plastic (e.g., Plexiglas) is difficult to transport and rig safely.

The light source itself can be any suitable video display panel, such as a plasma screen, an LED wall, an LCD screen, a monitor, a TV, a tablet, a mobile phone, etc. A variety of sizes can be used. When an image (e.g., stationary or moving) is shown on the video panel display 270, such as a person or object within an otherwise black (or other stable dark color) background, that image is then reflected onto the transparent screen (e.g., tensioned foil or otherwise), appearing to the viewer (shown as the stick figure) in a manner according to Pepper's Ghost Illusion. However, different from the original Pepper's Ghost Illusions using live actors/objects, and different from projector-based holographic systems, the use of video panel displays reduces or eliminates the “light beam” effect through atmosphere (e.g., fog), allowing for a clearer and un-tainted visual effect of the holographic projection. (Note that various diffusion layers may be used to reduce visual effects created by using video panel displays, such as the Moiré effect.) Also, using a video panel display 270 may help hide projector apparatus, and may reduce the overall size of the holographic system.

Additionally, some video panels such as LED walls are able to generate a much brighter image than projectors are able to generate thus allowing the Pepper's Ghost Illusion to remain effective even in bright lighting conditions (which generally degrade the image quality). The brighter image generated from an LED wall also allows for objects behind the foil to be more well lit than they can be when using projection.

In addition, by displaying an image of an object or person with a black background on the light source, it is reflected onto the transparent flat surface so it looks like the object or person is floating or standing on its own. In accordance with typical Pepper's Ghost Illusion techniques, a stage or background can be put behind and/or in front of the transparent film so it looks like the object or person is standing on the stage, and other objects or even people can also be on either side of the transparent film.

In certain embodiments, to alleviate the large space requirement in setting up a Pepper's Ghost display (e.g., to display a realistic holographic projection, a large amount of depth is typically needed behind the transparent screen), an optical illusion background may be placed behind the transparent screen in order to create the illusion of depth behind the screen (producing a depth perception or “perspective” that gives a greater appearance of depth or distance behind a holographic projection).

In general, holographic projections may be used for a variety of reasons, such as entertainment, demonstration, retail, advertising, visualization, video special effects, and so on. The holographic images may be produced by computers that are local to the projectors or video panels, or else may be generated remotely and streamed or otherwise forwarded to local computers.

As an example, by streaming the video image of the performer as a video and projecting it onto a holographic projection system, a true concert or nightclub experience can be transmitted across the globe for the live entertainment experience. For instance, holographically live-streaming concerts to satellite venues around the globe while maintaining the live concert experience helps artists reach new markets and new revenue streams, while bringing live sets to more fans all across the world. Satellite venues can be configured to have the same concert feel as an actual show: intense lighting effects, great sound quality, bars, merchandise, etc. The only difference is that the performers are not physically present, but are holographically projected from the broadcast venue. The music is streamed directly from the soundboard of the broadcast venue and sent to state-of-the-art sound systems at the satellite venues. Light shows may accompany the performance with top of the line LED screens and lasers.

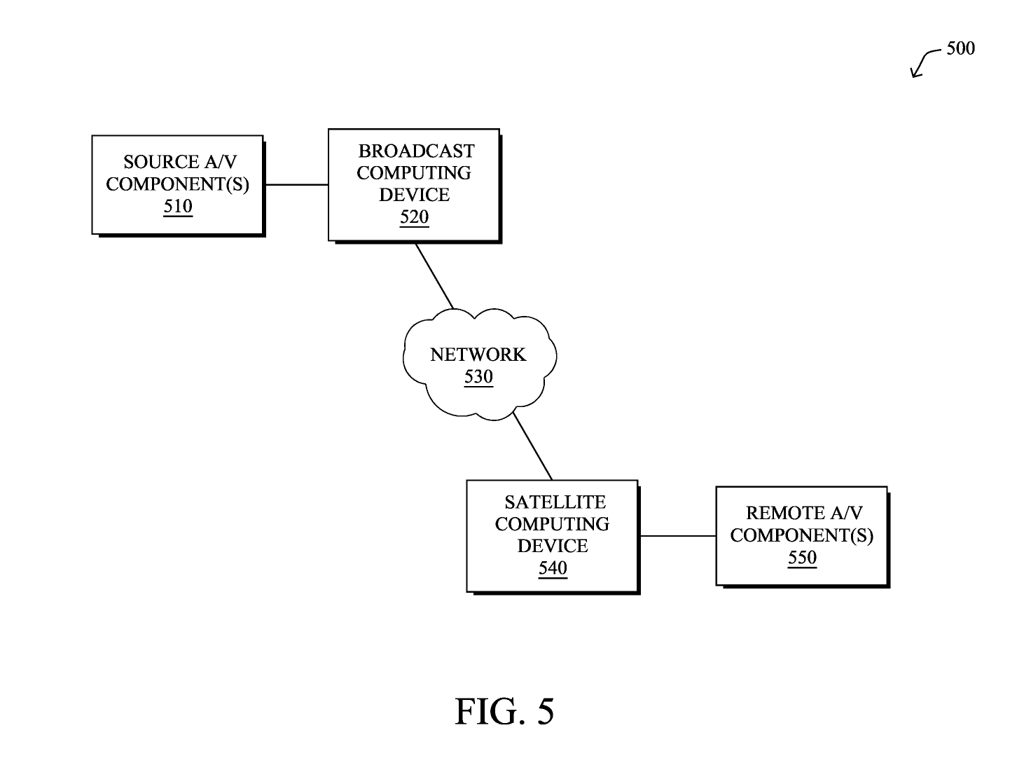

For instance, FIG. 5 illustrates an example simplified holographic projection system (e.g., communication network), where the network 500 comprises one or more source A/V components 510, one or more “broadcast” computing devices 520 (e.g., a local computing device), a communication network 530 (e.g., the public Internet or other communication medium, such as private networks), one or more “satellite” computing devices 540 (e.g., a remote computing device), and one or more remote A/V components 550.

In the example above, a broadcast venue may comprise the source A/V components 510, such as where a performance artist is performing (e.g., where a disc jockey (DJ) is spinning) in person. The techniques herein may then be used to stream (relay, transmit, re-broadcast, etc.) the audio and video from this broadcast location to a satellite venue, where the remote A/V components 550 are located. For instance, the DJ in the broadcast location may have the associated audio, video, and even corresponding electronic effects (lights, pyrotechnics, etc.) streamed directly to the satellite venue's A/V system with the same high quality sound as if the musician/artist was playing/singing in person.

As another example, in computing, an “avatar” is the graphical representation of the user (or the user's alter ego or other character). Avatars may generally take either a two-dimensional (2D) form or three-dimensional (3D) form, and typically have been used as animated characters in computer games or other virtual worlds (e.g., in addition to merely static images representing a user in an Internet forum). To control an avatar or other computer-animated model (where, notably, the term “avatar” is used herein to represent humanoid and non-humanoid computer-animated objects that may be controlled by a user), a user input system converts user action into avatar movement.

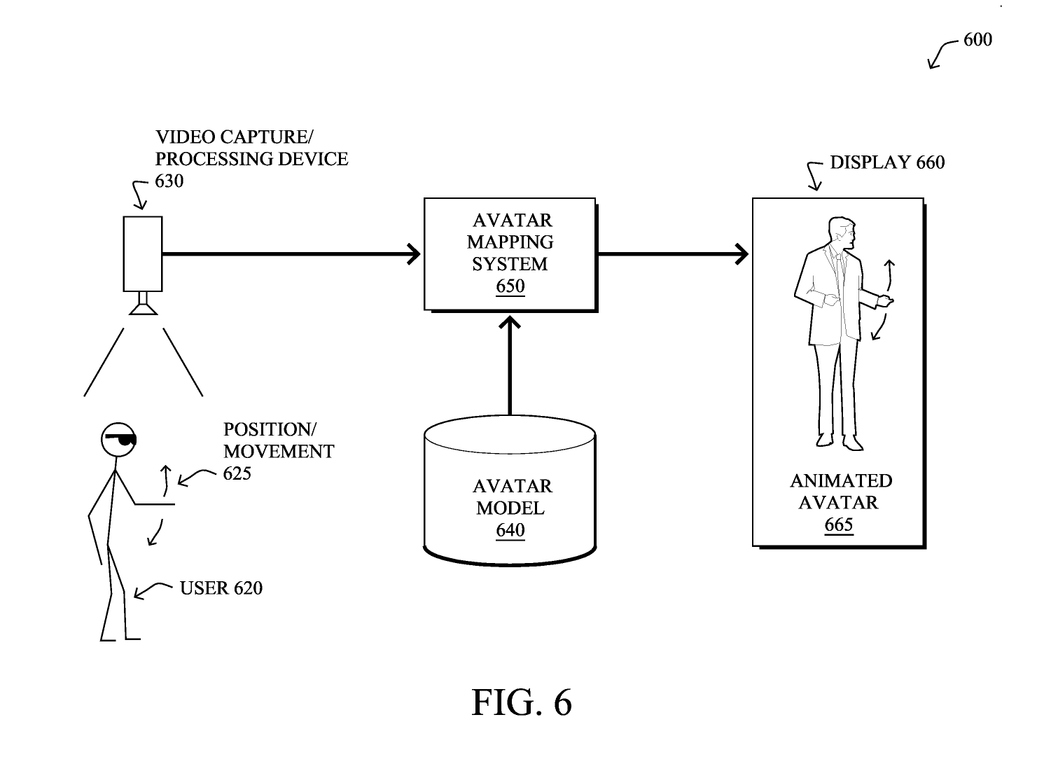

FIG. 6 illustrates a simplified example of an avatar control system. In particular, as shown in the system 600, a video capture/processing device 610 is configured to capture video images of one or more objects, particularly including one or more users 620 that may have an associated position and/or movement 625. The captured video data may comprise color information, position/location information (e.g., depth information), which can be processed by various body tracking and/or skeletal tracking algorithms to detect the locations of various tracking points (e.g., bones, joints, etc.) of the user 620. An avatar mapping system 650 may be populated with an avatar model 640, such that through various mapping algorithms, the avatar mapping system is able to animate an avatar 665 on a display 660 as controlled by the user 620. Illustratively, in accordance with the techniques herein the display 660 may comprise a holographic projection of the model animated avatar 665, e.g., allowing an individual to interactively control a holographic projection of a character. (Notably, the avatar mapping system 650 may provide its control functionality in real-time or as a recorded/post-production video feed, and may be co-located with the video processing system 630, remotely located from the video processing system, or as divided components allowing it to be both local to and remote from the video processing system.)

—Contoured Bounce for an Enhanced Pepper's Ghost Illusion—

As mentioned above, a contoured bounce for an enhanced Pepper's Ghost Illusion herein allows for contorting a bounce to different shapes, giving it enhanced three-dimensional (3D) effect.

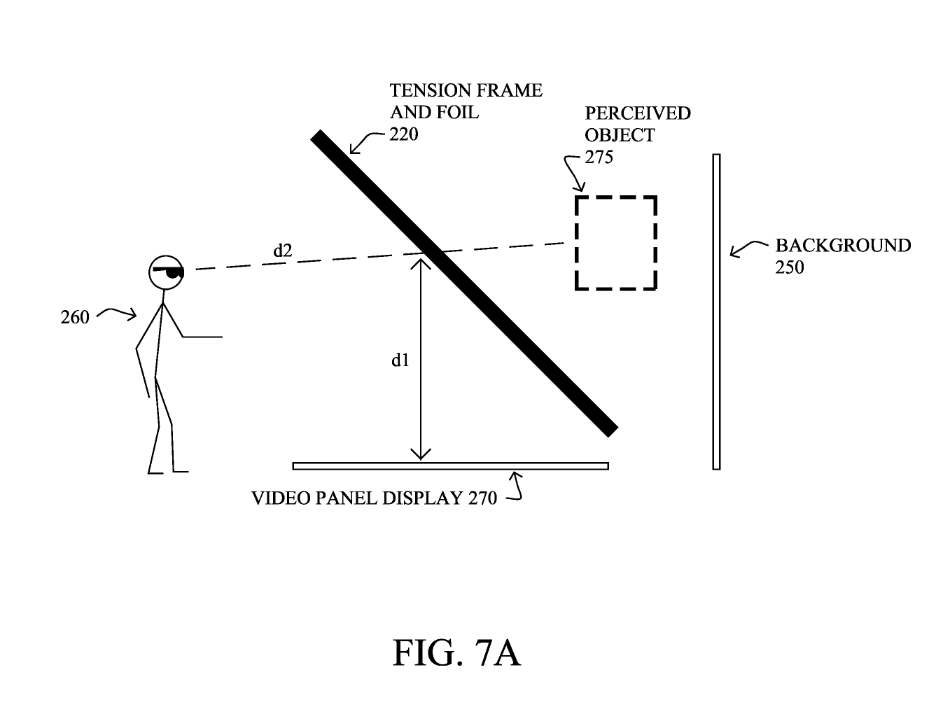

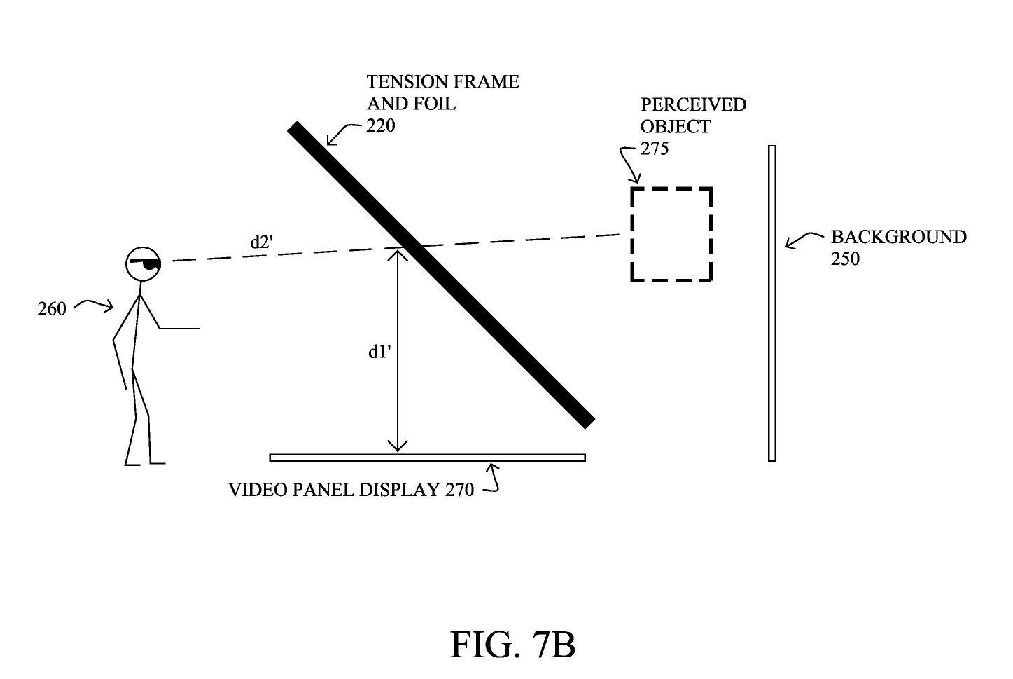

For instance, the perception of depth with a holographic image may be based on a number of factors, such as the size of the object, position of the object, etc., but most importantly in a Pepper's Ghost Illusion system, based on the distance of the image source from the holographic screen (glass, foil, etc.). This is illustrated in FIGS. 7A and 7B, where the difference in “height” of the image source 270 (e.g., a video panel display) corresponds to a difference in perceived depth of an object 275. Specifically, in FIG. 7A, the image source 270 is closer to the holographic screen 220 (distance d1), and thus the object 275 appears closer (distance d2) to the viewer 260. Conversely, in FIG. 7B, the image source 270 is further away (d1′), and thus the object 275 appears further away (d2′) to the viewer.

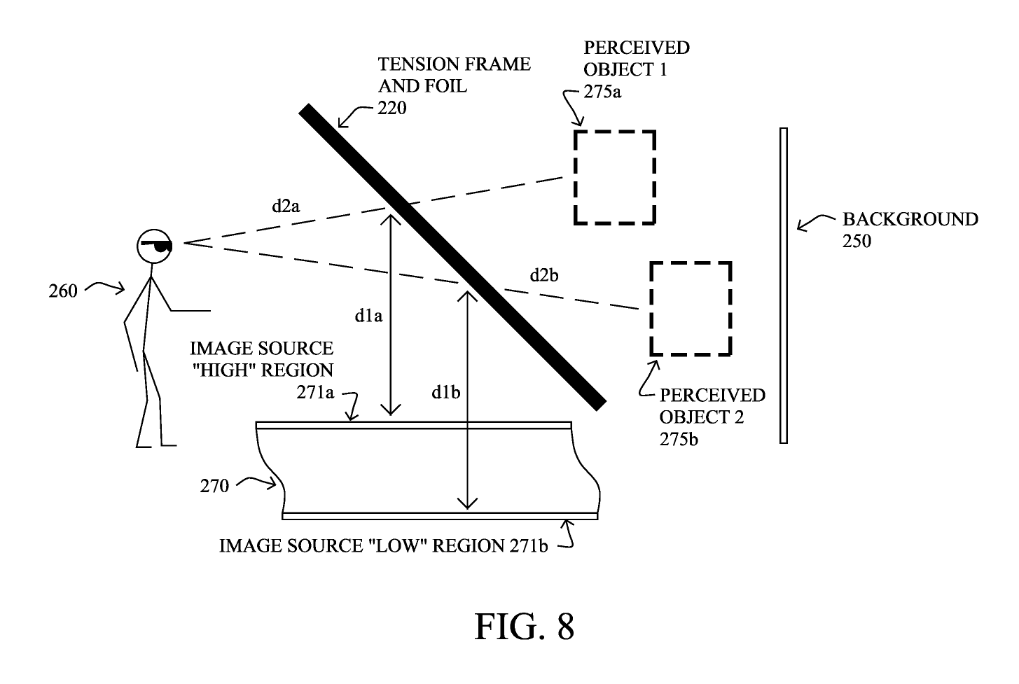

One aspect of the techniques herein takes advantage of this feature, though the techniques herein also provide a system that enhances the 3D perception of holographic objects (people, objects, avatars, etc.) to a viewer. In particular, as shown in FIG. 8, a contoured image source 270 (e.g., projector bounce, though contoured panel displays may be created by an array of flat panel displays) may be shaped with a topography to include regions of different heights 271a/271b (i.e., different distances d1a and d1b from the holographic screen), resulting in a displayed image 275a/275b appearing to have regions at different depths to the viewer (distances d2a and d2b). In one example use case, a holographic person can be “front and center” at one region that extends closer to the screen, while one or more objects can be “in the background” at another region further from the screen, such as for a singer and backup dancers, a speaker and an audience, a person and an object behind them, and so on.

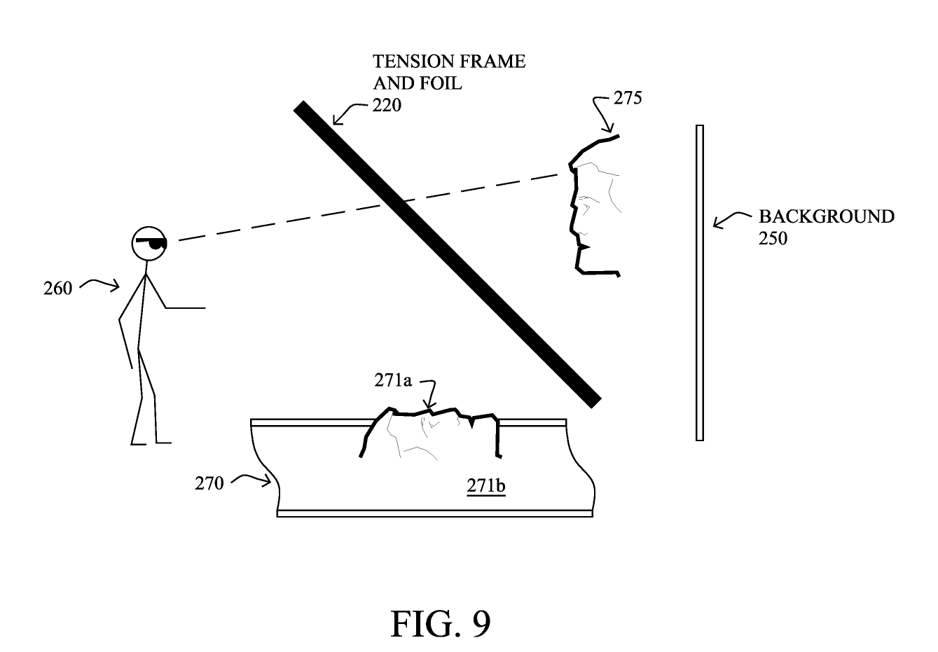

In addition to the location of different objects, the techniques herein may contour the image source with certain topography (raised or depressed portions) in a manner that accentuates certain features of a displayed object. For example, as shown in FIG. 9, the image source 270 (e.g., bounce) may be contoured (portion 271a) to the 3D shape of a human face. By then projecting an image of a human face onto the image source, the resulting holographic image 275 seen by the viewer 260 will have greatly realistic depth perspective.

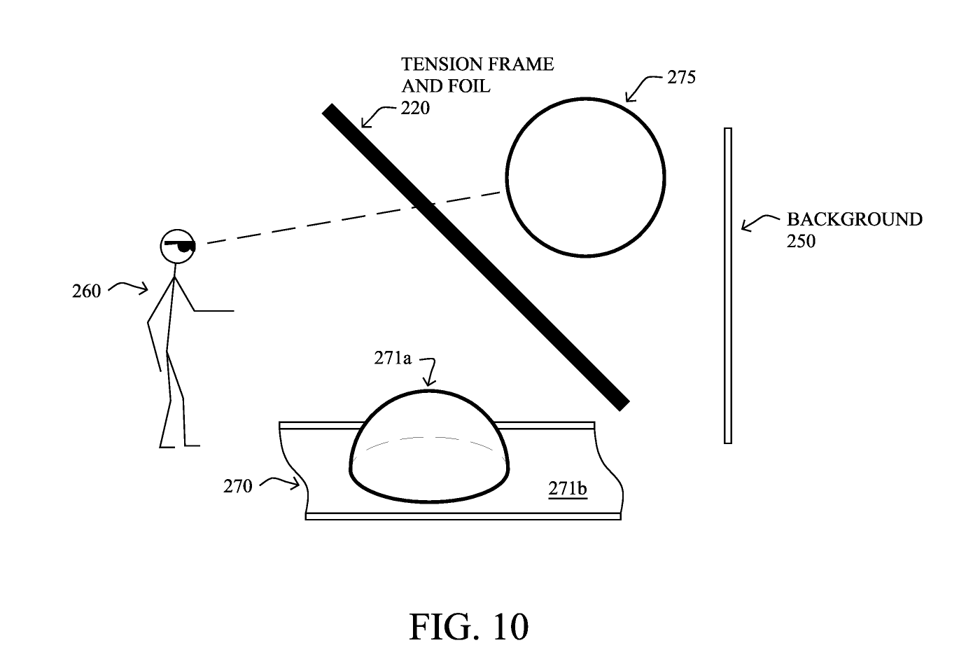

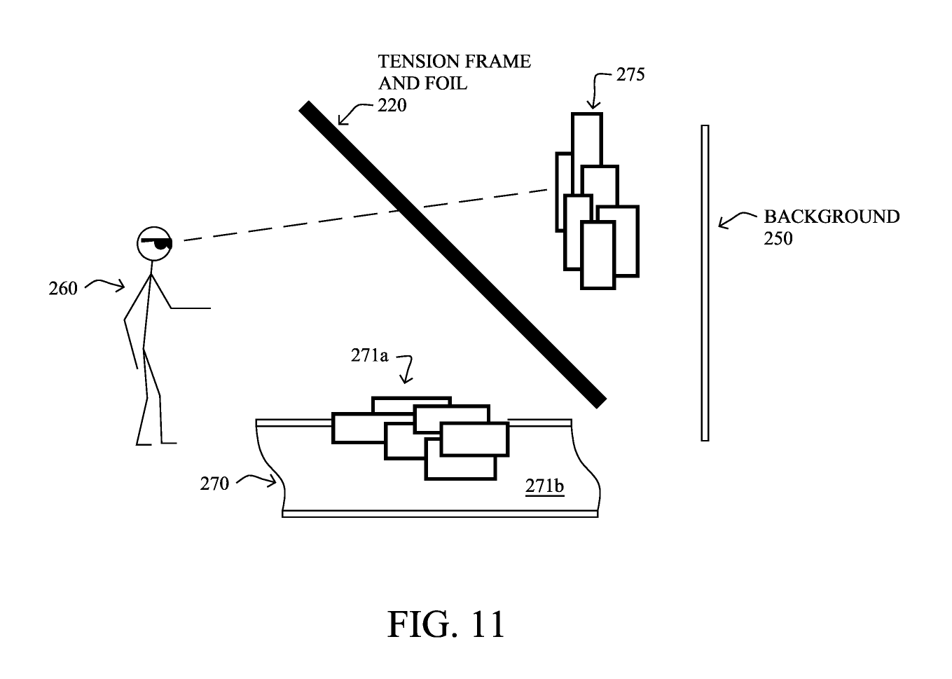

As another example, as shown in FIGS. 10-11, other 3D shapes (e.g., cubes, semi-spheres, etc.) may be used as well. For example, FIG. 10 illustrates a semi-sphere onto which various objects may be projected, such as the Earth or other planets, and as such, to a viewer, their 3D curvature would be greatly realistic. At the same time, FIG. 11 illustrates the use of one or more cube or rectangular shapes to create a 3D-immersive cityscape.

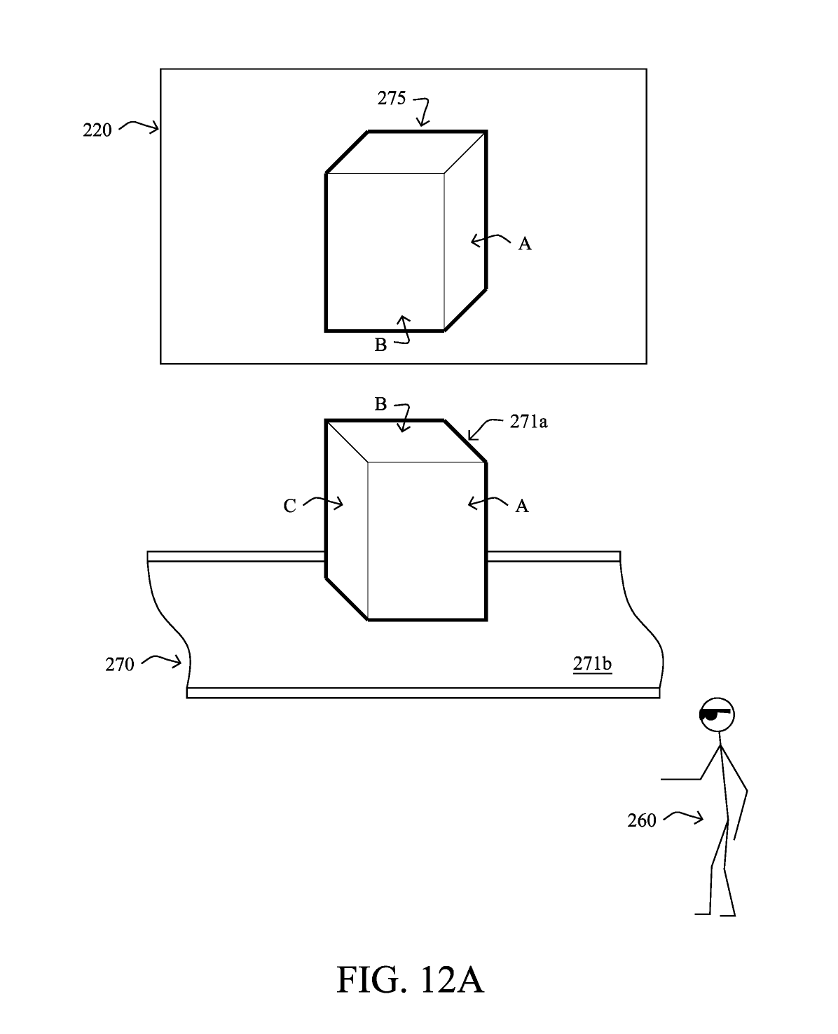

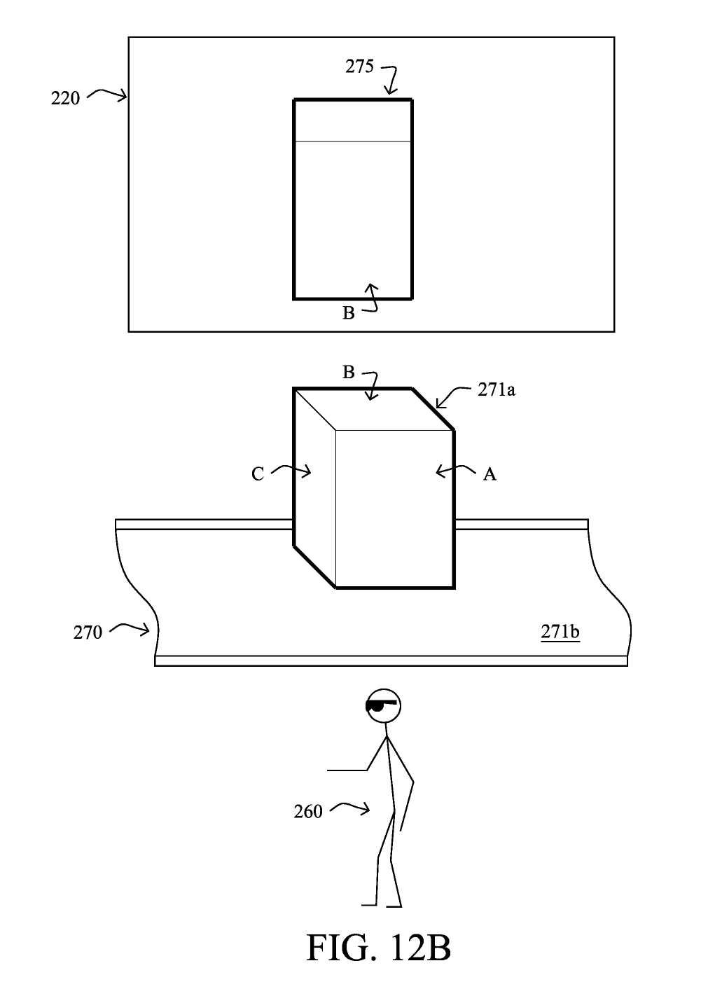

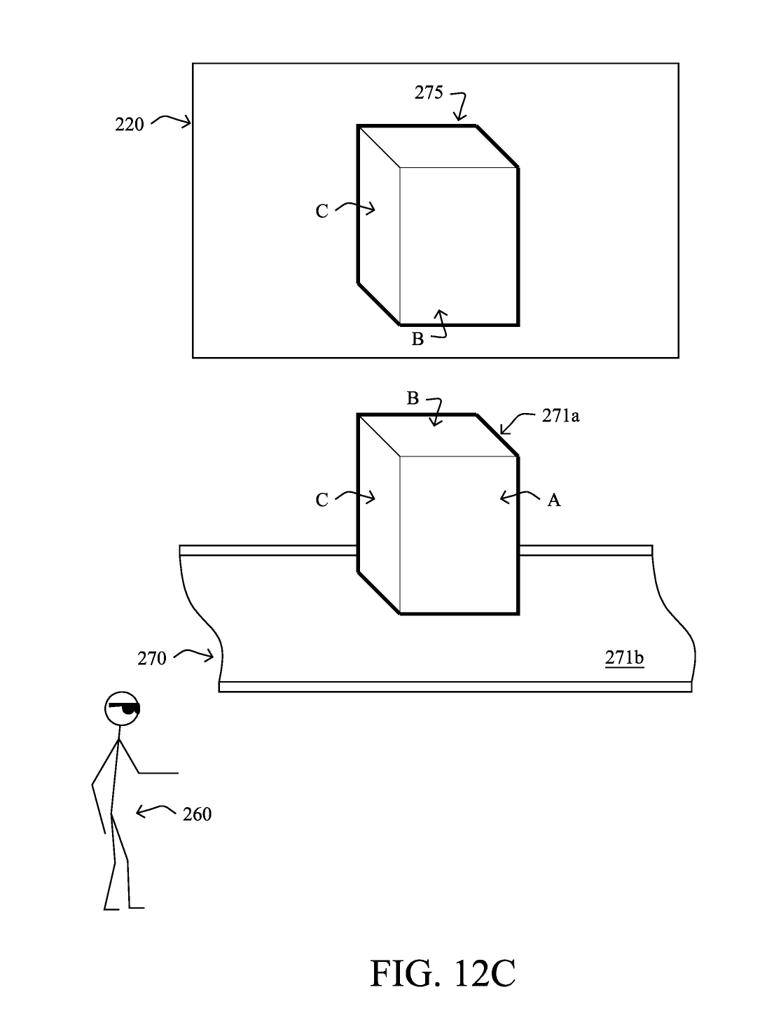

According to another aspect of the techniques herein, and in accordance with the present invention, two or more projectors (or display panels) can be used to projection map the bounce from different angles/sides. For instance, as shown in FIGS. 12A-C, a simplified version of the city shown above in FIG. 11 may include a single building or cube (contour 271a), with sides “A”, “B”, and “C”. While the bounce 270 remains at a 45-degree angle to the holographic screen 220 (foil/glass/etc.), the use of imagery on a 3D contour creates a more realistic 3D effect, and allows different perspectives/views of a holographic object 275 depending on from what angle a viewer is viewing the screen (e.g., a person walking by the display may see a realistic perspective that changes during the walk-by).

For example, when projectors map a building facade to that cube shape, the image on the foil will appear to be a building, generally. However, from one side (FIG. 12A), the user might see more of side “A”. When directly in front of the screen (FIG. 12B), on the other hand, the user might see more of side “B”, and less of sides “A” and “C”. Once the viewer is at the left of the screen (FIG. 12C), then side “C” starts to become more prevalent. In this manner, when a person stands on the far sides of the holographic system, they will see the sides of the building (or city, or whatever object/scene is depicted), but as they walk to the center they will see the front side of the building (city/etc.), which is currently not possible with a flat bounce.

The techniques herein may thus be used to create a depth differential between holographic objects, a three-dimensionally contoured object, or else to create a changing perspective 3D view of one or more objects. In general, the image source (e.g., bounce, generally), may be statically designed for the particular visual purpose of the setup, though dynamic changes may take place (e.g., stretching the bounce from behind to change the present contouring). Such dynamic changes can be made manually or automatically through pistons, hydraulic flooring, etc.

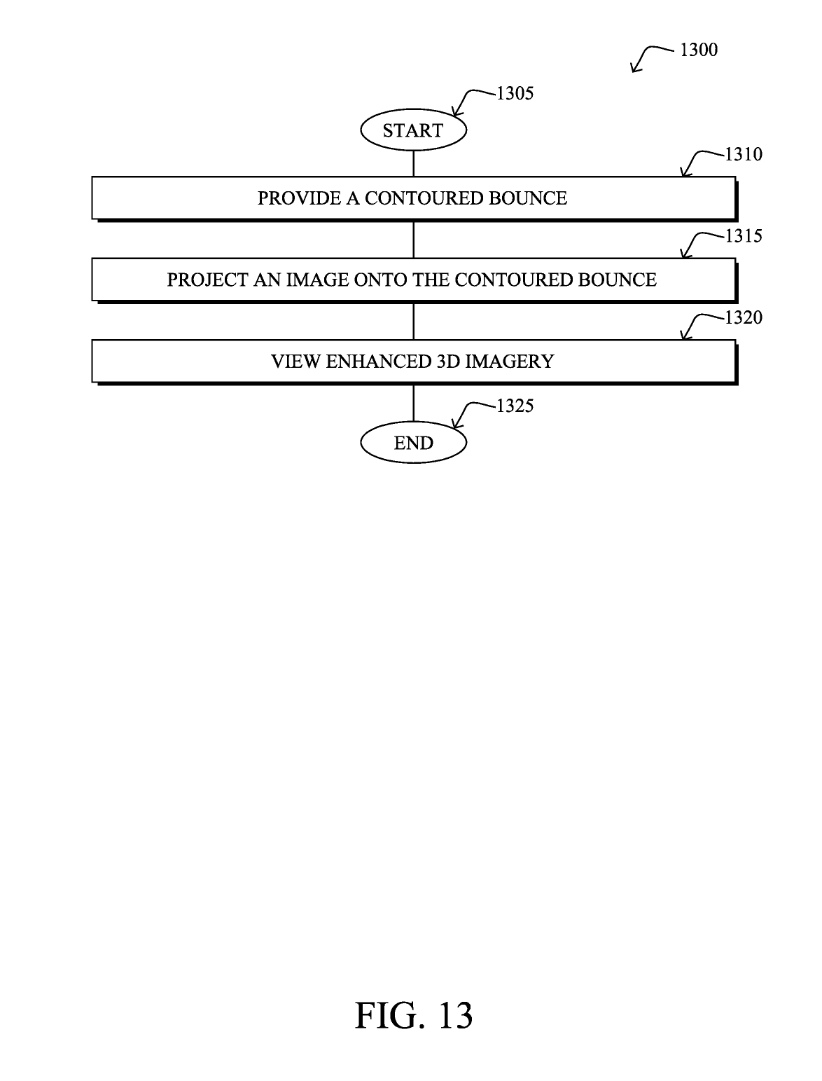

FIG. 13 illustrates an example simplified procedure for using a contoured bounce for an enhanced Pepper's Ghost Illusion in accordance with one or more embodiments described herein. The simplified procedure 1300 may start at step 1305, and continues to step 1310, where a contoured bounce (image source, generally) is provided. In step 1315, an image is projected onto the contoured bounce, e.g., by one or more projectors as mentioned above. As such, in step 1320, a viewer can view the enhanced 3D imagery as described above, whether for greater 3D realism, or else seeing a perspective change while walking past the holographic system. The procedure ends in step 1325.

Advantageously, the techniques herein provide for a contoured bounce for an enhanced Pepper's Ghost Illusion. In particular, as mentioned above, the techniques described herein allow for contorting a bounce to different shapes, giving it enhanced 3D effect. By using two or more projectors or panels to source different angles/sides, a more realistic 3D effect is created, allowing a person walking by the display to see a realistic perspective.

—Multi-Level Image Source for an Enhanced Pepper's Ghost Illusion—

As mentioned above, a multi-level image source for an enhanced Pepper's Ghost Illusion allows for multiple image sources (e.g., projected bounces and/or panel displays) to be placed at different heights with respect to a transparent viewing screen, thus projecting images that appear at various depths, increasing the three-dimensional (3D) effect of the Pepper's Ghost Illusion.

Again, the perception of depth with a holographic image may be based on a number of factors, such as the size of the object, position of the object, etc., but most importantly in a Pepper's Ghost Illusion system, based on the distance of the image source from the holographic screen (glass, foil, etc.). This was illustrated in FIGS. 7A and 7B, above, where the difference in height of the image source corresponds to a difference in perceived depth of an object (closer in FIG. 7A, further away in FIG. 7B).

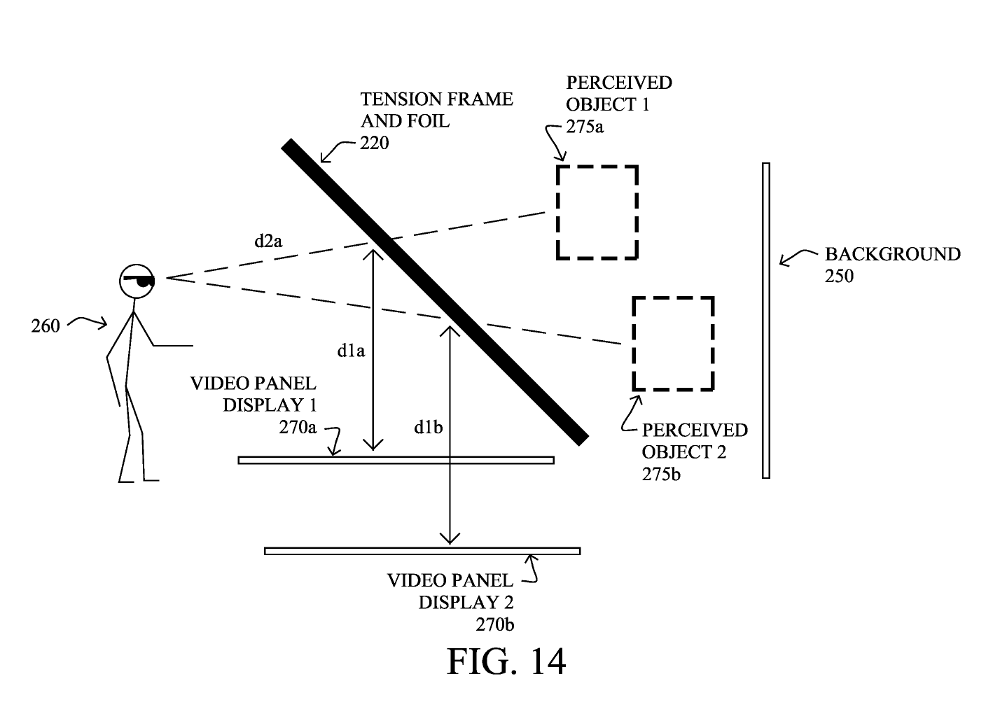

The techniques herein further take advantage of this feature, and provide a system that enhances the 3D perception of holographic objects (people, objects, avatars, etc.) to a viewer in another manner than that described above. In particular, as shown in FIG. 14, multiple image sources 270a/270b (e.g., display panels and/or projector bounces) may be used at different heights (i.e., different distances d1a/d1b from the holographic screen 220), resulting in their correspondingly displayed images 275a/275b appearing at different depths d2a/d2b to the viewer 260 in front of background 250.

In one example use case, one holographic person can be “front and center”, while one or more others can be “in the background”, such as for a singer and backup dancers, a speaker and an audience, a person and an object behind them, and so on. Note that though only two image sources are shown, any number may be used, and in any relation. For instance, while they are shown side-by-side, other arrangements, such as in front or behind, or combinations for multiple objects, are also possible.

In addition, while the difference in heights of the image sources can be configured and static, in one embodiment of the present invention, the heights of the image sources may be adjusted (e.g., manually or dynamically), making corresponding holographic images change their depth perspective to an audience, further enhancing the 3D effect.

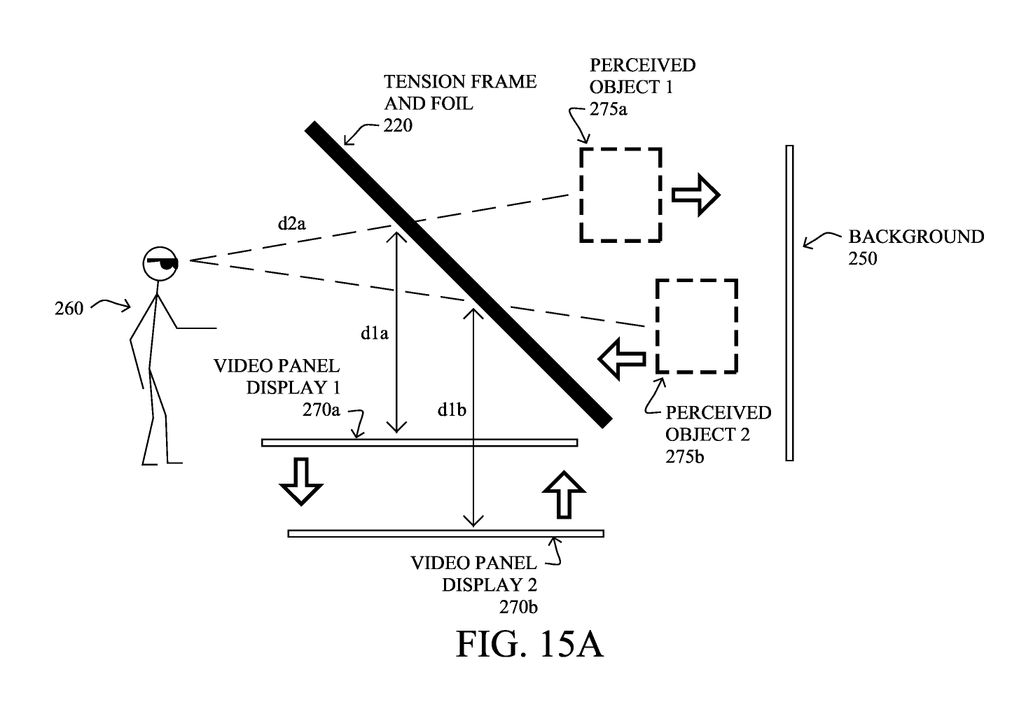

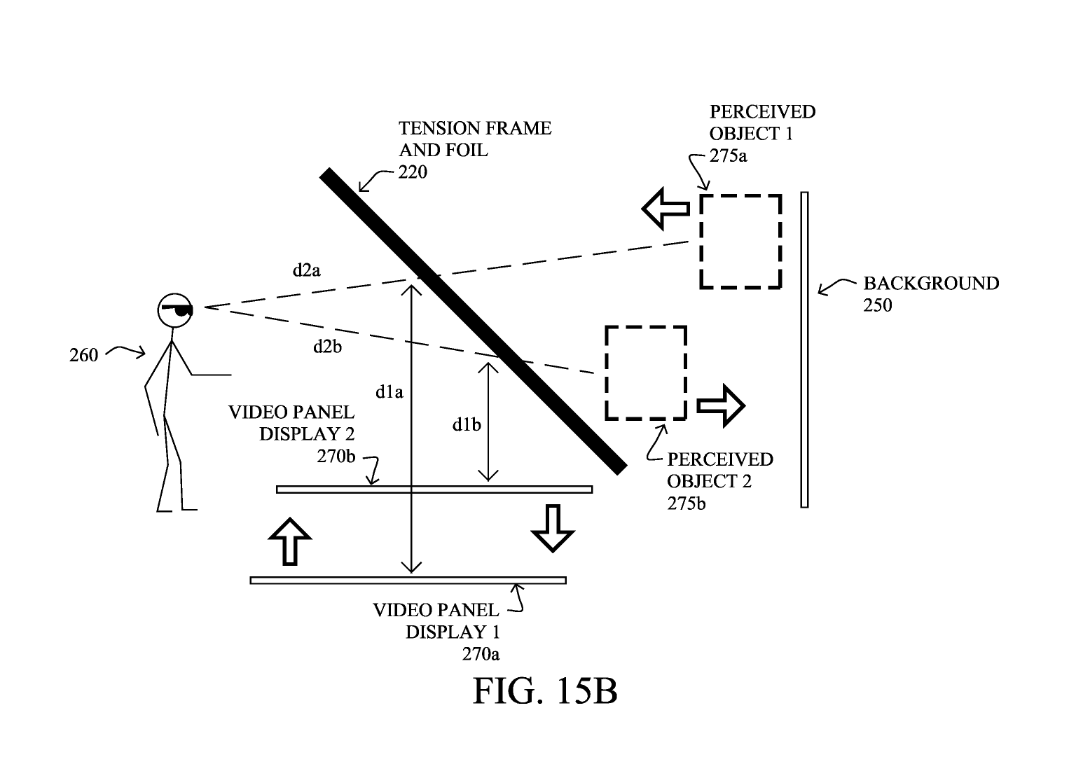

For instance, as shown in FIGS. 15A and 15B, the heights of the image sources may be changed, resulting in a corresponding change in perceived depth of the objects. In this manner, a dynamic display may be created, such as changing which objects are in the foreground and background dynamically. For example, when two holographic people are talking to an audience, the one speaking can be brought to the front, while the other is brought to the back. This may also be useful for presentations or demonstrations, where various objects are emphasized based on their depths at different times during the display.

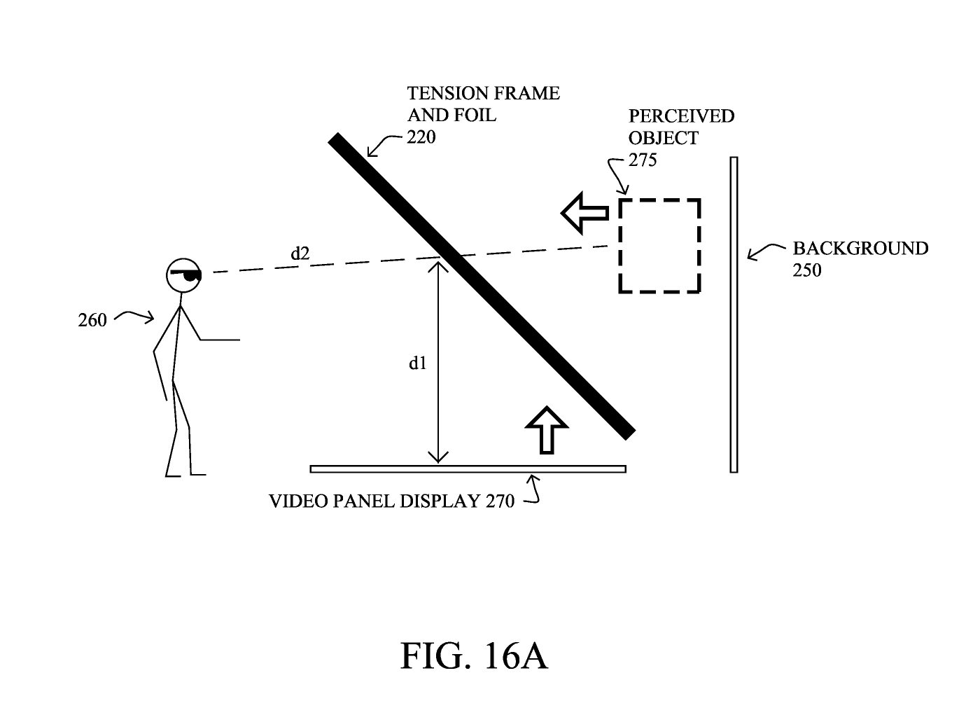

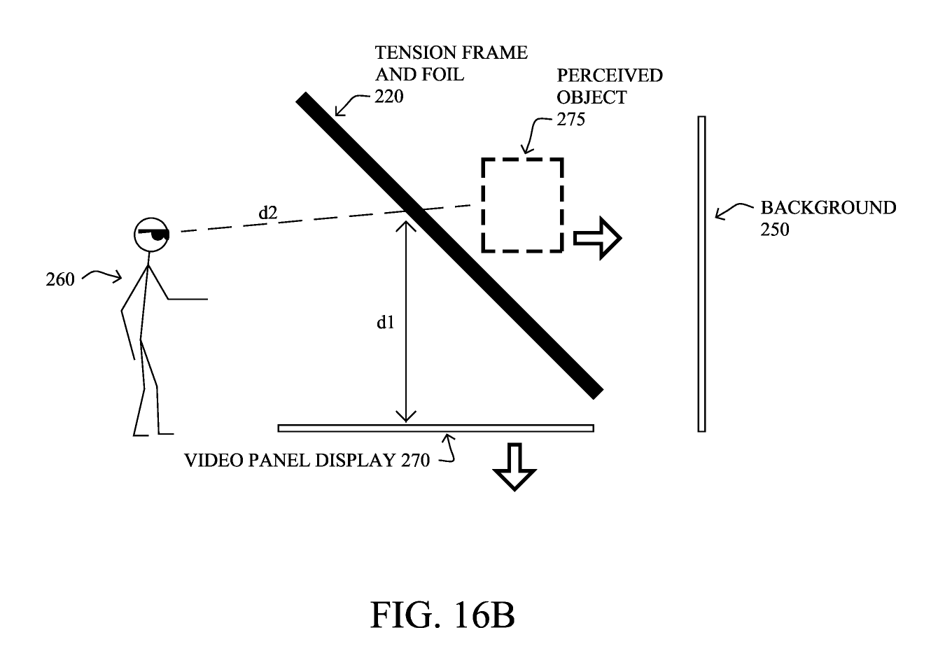

Additionally, as shown in FIGS. 16A and 16B, the same concept is available for moving a single image source, thus moving a single object's depth correspondingly.

According to one or more embodiments herein, the height of the one or more image sources can be changed based on pre-configured timings in a corresponding display program (e.g., to control one or more motors), or based on stage hands manually adjusting the height. In still another embodiment, the image source(s) can be dynamically moved based on a detected depth of the object, whether live-streamed or else pre-recorded.

In order to accomplish object-depth-based control of image source height in this manner, a video capture device that videos the object may comprise a camera that is capable of detecting object distance. One such example camera that is commercially available is the KINECT™ camera system available from MICROSOFT™, and as such, certain terms used herein may be related to such a specific implementation. However, it should be noted that the techniques herein are not limited to a KINECT™ system, and other suitable video capture and processing systems may be equally used with the embodiments described herein.

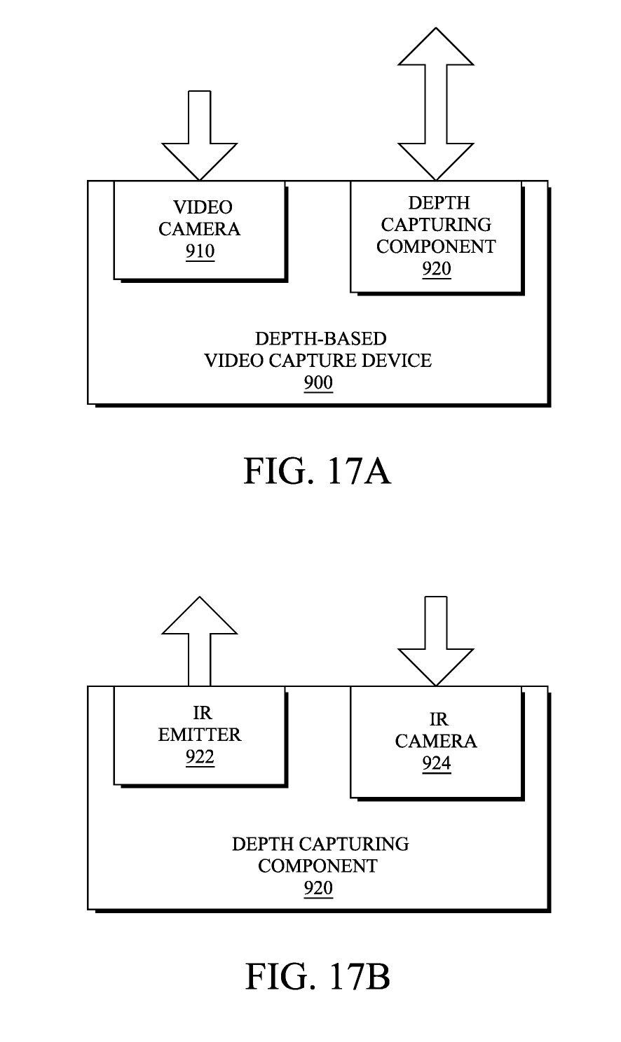

Illustratively, as shown in FIG. 17A, a depth-based video capture device 900 may comprise two primary components, namely a video camera 910 and a depth-capturing component 920. For example, the video camera 910 may comprise a “red, green, blue” (RGB) camera (also called a color video graphics array (VGA) camera), and may be any suitable rate (e.g., 30 or 60 frames per second (fps)) and any suitable resolution (e.g., 640×480 or greater, such as “high definition” resolutions, e.g., 1080p, 4K, etc.).

The depth capturing component 920 may comprise two separate lenses, as illustrated in FIG. 17B, such as an infrared (IR) emitter 922 to bathe the capture space in IR light, and an IR camera 924 that receives the IR light from the IR emitter as it is reflected off of the objects within the capture space. For instance, the brighter the detected IR light, the closer the object is to the camera. One specific example of an IR camera is a monochrome CMOS (complimentary metal-oxide semiconductor) sensor. Notably, the IR camera 924 (or depth capturing component 920, generally) may, though need not, have the same frame rate and resolution as the video camera 910 (e.g., 30 fps and 640×480 resolution). Note also that while the video camera 910 and depth capturing component 920 are shown as an integrated device, the two components may be separately located (including separately locating the illustrative IR emitter 922 and IR camera 924), so long as there is sufficient calibration to collaboratively determine portions of the video image based on depth between the separately located components.

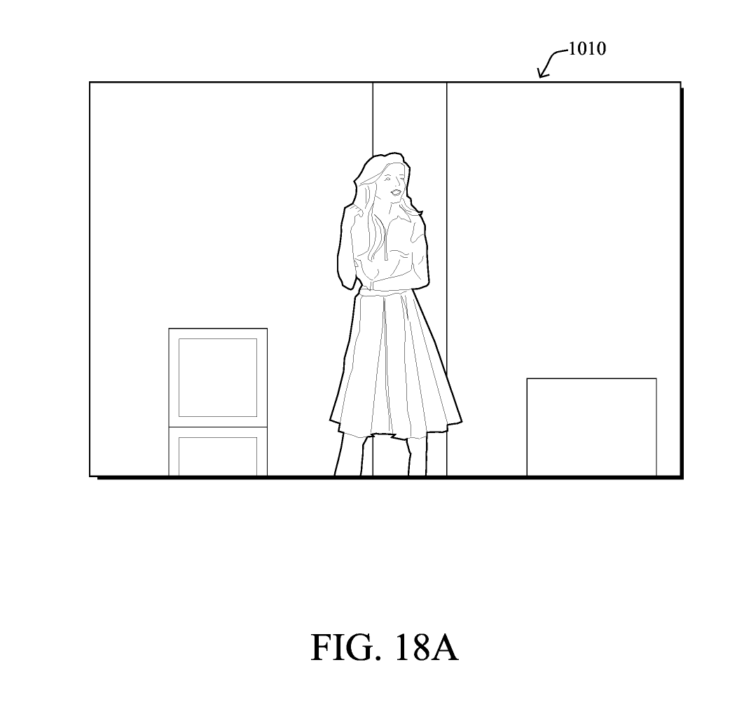

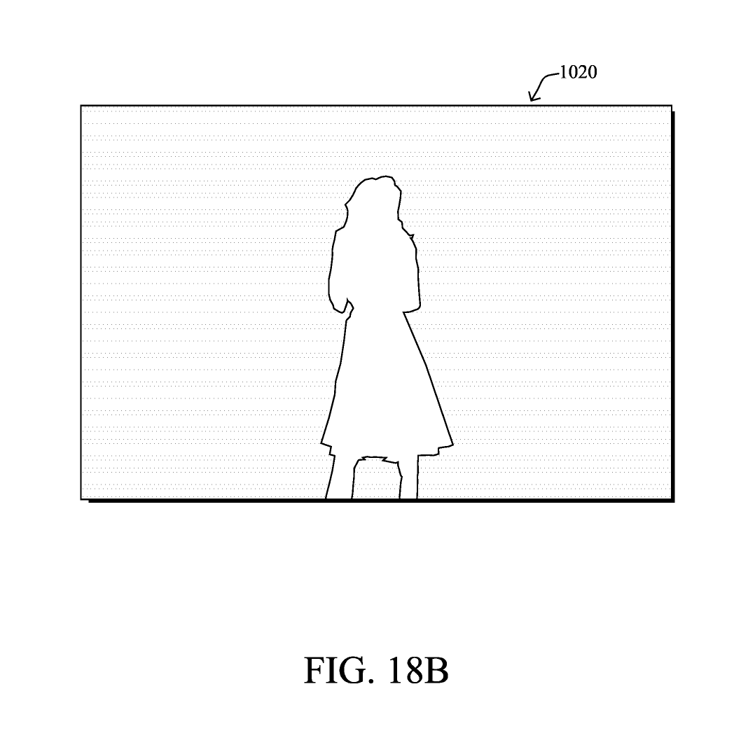

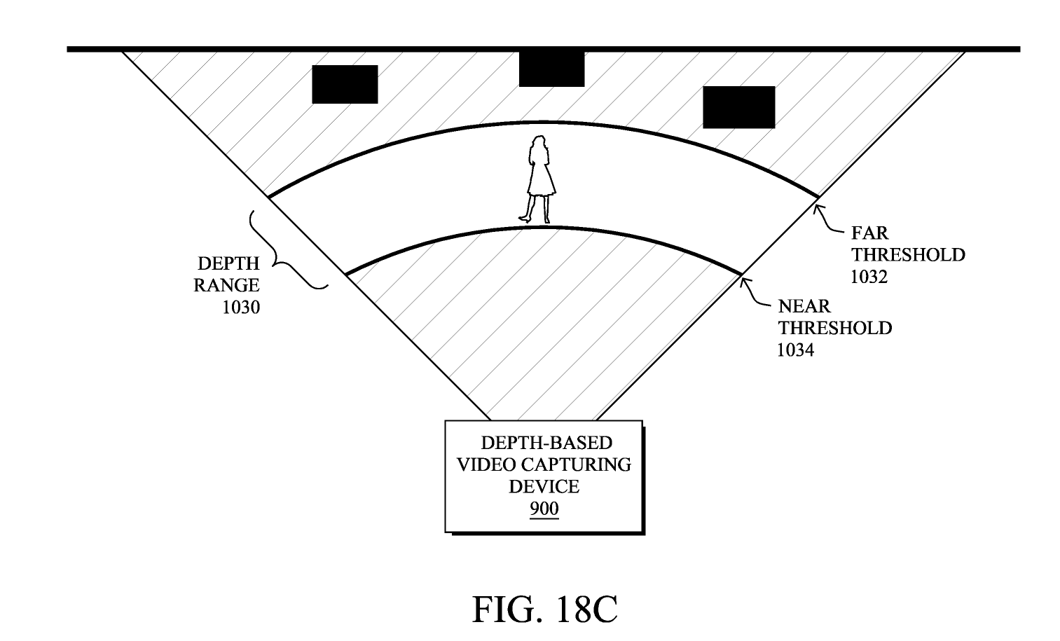

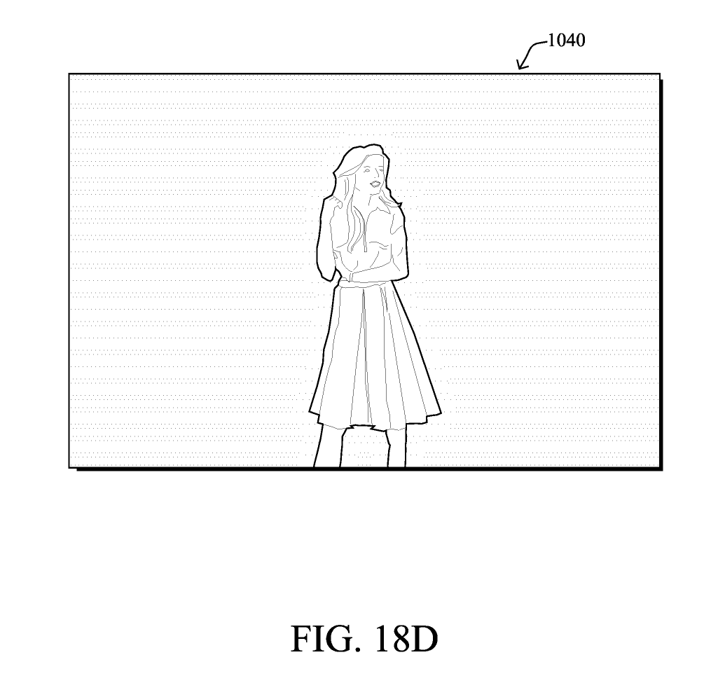

Based on the images from the camera 900, a corresponding depth range of a captured object may be set and/or determined using the captured depth information (e.g., IR information). For example, FIG. 18A illustrates an example source image 1010 that may be captured by the video camera 910. Conversely, FIG. 18B illustrates an example depth-based image 1020 that may be captured by the depth capturing component 920, such as the IR image captured by the IR camera 924 based on reflected IR light from the IR emitter 922. In particular, the image 1020 in FIG. 18B may be limited (manually or dynamically) to only show the desired depth range of a given subject (person, object, etc.), such as based on the intensity of the IR reflection off the objects.

According to one or more embodiments herein, the depth range selected to produce the image 1020 in FIG. 18B may be adjusted on-the-fly (e.g., manually by a technician or dynamically based on object detection technology) in order to control what can be “seen” by the camera. For instance, the techniques herein thus enable object tracking during live events, such as individual performers move around a stage. For example, as shown in FIG. 18C, an aerial view of the illustrative scene is shown, where the desired depth range 1030 may be set by a “near” depth threshold 1034 and a “far” depth threshold 1032. As an example, a user may be prompted to press the ‘−’ or ‘+’ keys on a keyboard to decrease and increase the near threshold, respectively, and the ‘<’ or ‘>’ keys to correspondingly decrease and increase the far threshold, respectively. Other techniques (and particularly user inputs/keys) may be made available, such as defining a center depth (distance from camera) and then a depth of the distance captured surrounding that center depth, or defining a near or far depth threshold and then a further or nearer depth (in relation to the near or far depth threshold), respectively. This can also be combined with other body tracking algorithms (e.g., as described below).

By then overlaying the depth information (IR camera information) of image 1020 in FIG. 18B with the video image 1010 from FIG. 18A, the techniques herein “cut out” anything that is not within a desired depth range, thus allowing the camera to “see” (display) whatever is within the set range, as illustrated by the resultant image 1040 in FIG. 18D. In this manner, the background image may be removed, isolating the desired person/object from the remainder of the visual scene captured by the video camera 910. (Note that foreground images may also thus be removed.)

By allowing for the dynamic and real-time adjustment of the depth range as mentioned above, a mobile object or person may be “tracked” as it moves in order to maintain within the depth range, accordingly. Notably, body tracking algorithms, such as skeletal tracking algorithms, may be utilized to track a person's depth as the person moves around the field of view of the cameras. For example, in one embodiment, the perspective (relative size) of the skeletally tracked individual(s) (once focused on that particular individual within the desired depth range) may result in corresponding changes to the depth range: for instance, a decrease in size implies movement away from the camera, and thus a corresponding increase in focus depth, while an increase in size implies movement toward the camera, and thus a corresponding decrease in focus depth. Other skeletal techniques may also be used, such as simply increasing or decreasing the depth (e.g., scanning the focus depth toward or away from the camera) or by increasing the overall size of the depth range (e.g., moving one or both of the near and far depth thresholds in a manner that widens the depth range).

Based on the set, tracked, adjusted, and/or determined depths of the objects that are being holographically portrayed, the image sources herein may be adjusted accordingly based on that depth information to portray a similar perspective aspect in the holographic image. For example, if one person walks toward a camera, and another walks away from the camera (whether the same camera or not), the image sources may be adjusted according to the techniques above based on the change in distance/depth each person was from the camera.

Note that the distance of the image source from the holographic foil need not match the actual distance measured, and need not be a linear relationship (i.e., instead being simplified to “closer” or “further”, rather than any particular algorithmic determination of perceived depths and corresponding image source height.

Also note that while the image sources have been shown as being on a “floor” of the system, image sources may also be located on the ceiling or sides/walls of the system, or any combination thereof (generally being approximately a 45-degree angle from the holographic screen/foil). The view herein is merely an example, and not meant to be limiting to the scope of the embodiments herein.

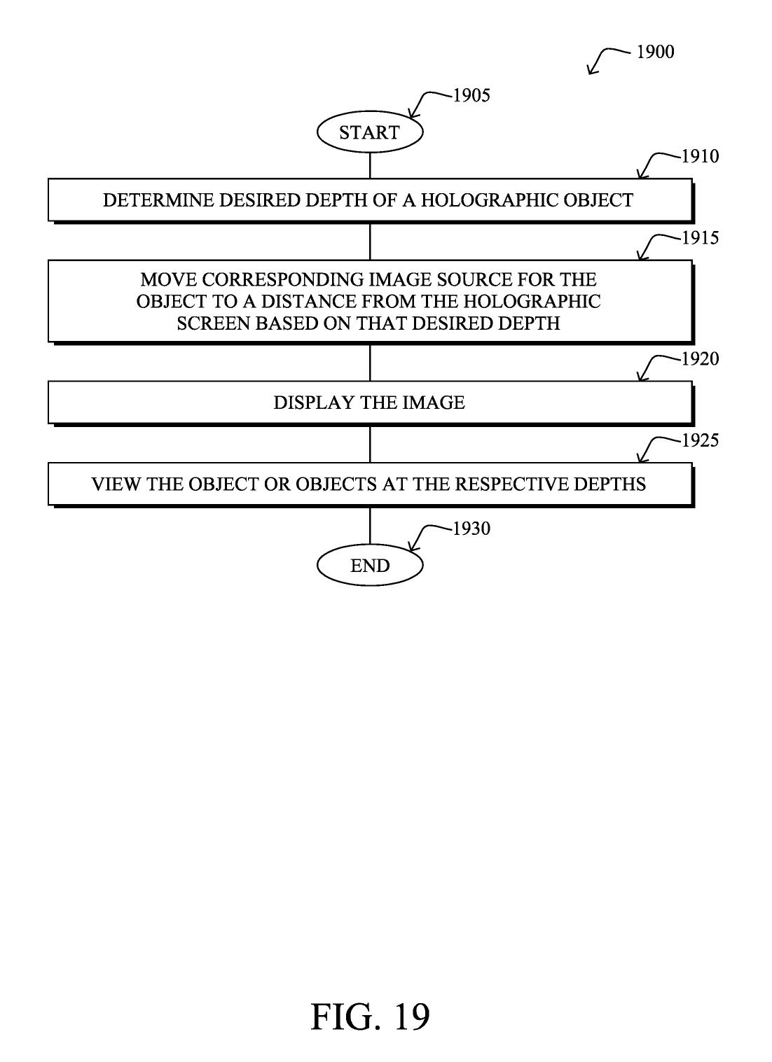

FIG. 19 illustrates an example simplified procedure for using a multi-level image source for an enhanced Pepper's Ghost Illusion in accordance with one or more embodiments described herein. The simplified procedure 1900 may start at step 1905, and continues to step 1910, where a desired depth of a holographic object is determined (e.g., based on any input described above). As such, a corresponding image source for the object may be moved to a distance from the holographic screen in step 1915 based on that desired depth. The image is displayed in step 1920 (i.e., if not already displayed during the distance setting in step 1915), and the viewer can see the object or objects at their respective depths in step 1925, accordingly. The simplified procedure ends in step 1930, notably with the ability to continue to adjust depths of objects.

Advantageously, the techniques herein also provide for a multi-level image source for an enhanced Pepper's Ghost Illusion. In particular, as mentioned above, the techniques described herein allow for multiple image sources (e.g., projected bounces and/or panel displays) to be used and placed at different heights with respect to a transparent viewing screen, thus projecting images that appear at various depths, increasing the 3D effect of the Pepper's Ghost Illusion. In addition, by adjusting the heights of the image sources (e.g., dynamically), the corresponding holographic images change their depth perspective to an audience, further enhancing the 3D effect.

While there have been shown and described illustrative embodiments, it is to be understood that various other adaptations and modifications may be made within the spirit and scope of the embodiments herein. For example, the embodiments described herein may be used with holographic projection images produced from a variety of sources, such as live-streamed, pre-recorded, re-constructed, computer-generated, and so on. Also, any reference to “video” or “image” or “picture” need not limit the embodiments to whether they are motion or time-sequence photography or still images, etc. Moreover, any holographic imagery techniques may be used herein, and the illustrations provided above are merely example embodiments, whether for two-dimensional or three-dimensional holographic images.

It should also be noted that while certain steps within procedures 1300 and 1900 may be optional as described above, the steps shown in FIG. 13 and FIG. 19 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 1300 and 1900 are described separately, certain steps from each procedure may be incorporated into each other procedure, and the procedures are not meant to be mutually exclusive.

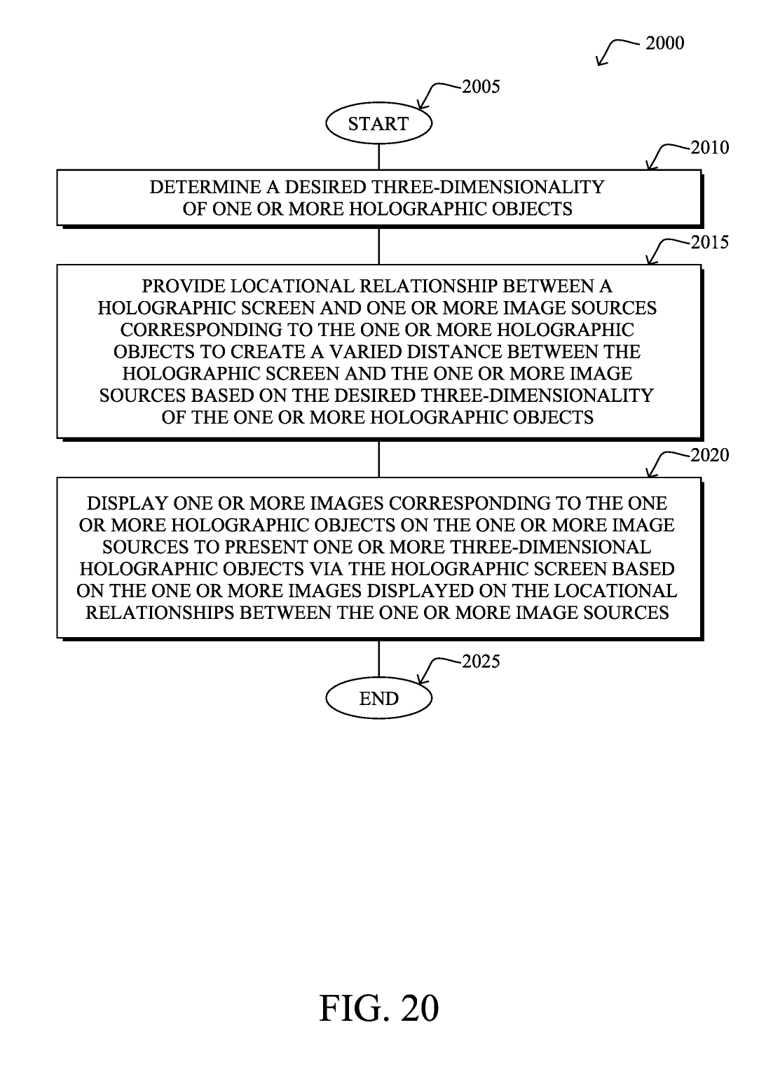

The same can be said for the different embodiments described above. That is, while a contoured bounce and multi-level image source are described generally separately above, various concepts from each may be applicable to each other embodiment, such as moving a contoured bounce, dynamically contouring a bounce, or otherwise, based on changing depth of an object, etc. Accordingly, the techniques herein, in general with reference to FIG. 20 (with procedure 2000 which starts in step 2005), relate to determining a desired three-dimensionality of one or more holographic objects (step 2010); providing locational relationship between a holographic screen and one or more image sources corresponding to the one or more holographic objects to create a varied distance between the holographic screen and the one or more image sources based on the desired three-dimensionality of the one or more holographic objects (step 2015); and displaying one or more images corresponding to the one or more holographic objects on the one or more image sources to present one or more three-dimensional holographic objects via the holographic screen based on the one or more images displayed on the locational relationships between the one or more image sources (step 2020, with procedure 2000 illustratively ending in step 2025).

Further, the embodiments herein may generally be performed in connection with one or more computing devices (e.g., personal computers, laptops, servers, specifically configured computers, cloud-based computing devices, cameras, etc.), which may be interconnected via various local and/or network connections. Various actions described herein may be related specifically to one or more of the devices, though any reference to particular type of device herein is not meant to limit the scope of the embodiments herein.

The foregoing description has been directed to specific embodiments. It will be apparent, however, that other variations and modifications may be made to the described embodiments, with the attainment of some or all of their advantages. For instance, it is expressly contemplated that certain components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining a desired three-dimensionality of one or more holographic objects;
providing locational relationship between a holographic screen and one or more image sources corresponding to the one or more holographic objects to create a varied distance between the holographic screen and the one or more image sources based on the desired three-dimensionality of the one or more holographic objects; and
displaying one or more images corresponding to the one or more holographic objects on the one or more image sources to present one or more three-dimensional holographic objects via the holographic screen based on the one or more images displayed on the locational relationships between the one or more image sources.

2. The method as in claim 1, wherein the locational relationship is based on a contoured image source of the one or more image sources.

3. The method as in claim 1, wherein the locational relationship is based on a moveable image source of the one or more image sources.

4. The method as in claim 1, wherein the locational relationship is based on different distances of different image sources of the one or more image sources.

5. A method, comprising:
providing a contoured image source; providing a holographic screen configured to present a holographic object according to an image on the contoured image source;
displaying the image on the contoured image source; and
presenting a three-dimensional holographic object via the holographic screen based on the image displayed on the contoured image source.

6. The method as in claim 5, wherein the contoured image source is a projection bounce.

7. The method as in claim 5, wherein displaying comprises projecting from a plurality of projectors.

8. The method as in claim 5, further comprising:
dynamically changing a contour of the contoured image source.

9. The method as in claim 5, further comprising:
displaying a second image on the contoured image source;
wherein the three-dimensional holographic object presented via the holographic screen is based on the image being displayed on a first contour of the contoured image source and the second image displayed separately on a second contour of the contoured image source.

10. A method, comprising:
determining a desired display depth of a holographic object;
moving an image source corresponding to the holographic object to a distance from a holographic screen based on the desired display depth; and
displaying an image corresponding to the holographic object on the image source.

11. The method as in claim 10, further comprising:
determining the desired display depth based on pre-configured timings in a display program.

12. The method as in claim 10, further comprising:
moving the image source manually.

13. The method as in claim 10, further comprising:
determining the desired display depth based on detecting a depth of the holographic object with relation to a video input originally capturing the image corresponding to the holographic object.

14. The method as in claim 10, further comprising:
determining a second desired display depth of a second holographic object;
moving a second image source corresponding to the second holographic object to a second distance from a holographic screen based on the second desired display depth;
and displaying a second image corresponding to the second holographic object on the second image source.

15. The method as in claim 10, wherein the image source is contoured.
